(19) United States
(12) Patent Application Publication
(10) Pub. No.: US 2004/0229636 A1
(43) Pub. Date: Nov. 18, 2004

(54) Broadcast message service method in mobile communication terminal

(75) Inventor: Do Hoon Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/838,358

(22) Filed: May 5, 2004

(30) Foreign Application Priority Data
May 15, 2003 (KR) KR 30981/2003

(51) Int. Cl. H04Q 7/20

(52) U.S. Cl. 455/466; 455/418

(57) ABSTRACT

A broadcast message service system and method comprises transmitting a broadcast message including information designating receivers' phone numbers and whether or not each receiver's phone number is to be opened once received, content of the broadcast message is certified and so is the opened receivers' phone numbers. Other receivers' phone numbers to which the same broadcast message has been transmitted or their information can also be certified, and phone numbers can be stored or edited by a receiver's arbitrary handling. Also, the receiver can transmit a reply short message, thereby increasing the user's convenience.

### BACKGROUND OF THE INVENTION

1. Field of the Invention

The present invention generally relates to a short message service in a mobile communication terminal, and more particularly to a broadcast message service method in a mobile communication terminal for providing a broadcast transmission service.

2. Description of the Related Art

As mobile communications become more popular, enhanced services such as a short message service (SMS)are being developed. In this service, a short message is transmitted to an opposition party's mobile terminal almost simultaneously with a transmission timing. SMS has therefore been recognized as being important for use with voice communications in a mobile terminal.

SMS service is an interactive service which transmits and receives short text messages without requiring a call to be established between mobile terminals. That is, the short message service enables a mobile communication service subscriber to receive a message through a public switched telephone network (PSTN), a data communication network, or an Internet when another mobile communication service subscriber or himself transmits a short message, which is approximately 80 bytes in length.

Generally, the short message service is performed between one call originator and one call receiver. Therefore, in order to transmit a short message of the same content to a plurality of receivers by a single originator, the same content of the short message has to be input, or a stored message has to be repeatedly called back retrieved from memory using a key adjustment and in addition the receiver's unique phone number has to be inputted. To solve this problem, a broadcast message function for simultaneously transmitting a single text message to a plurality of receivers has been proposed.

FIGS. 1A-1D show display windows generated by a broadcast message transmitting method in a mobile communication terminal in accordance with the related art, and FIGS. 2A-2C show display windows generated by a broadcast message receiving method in a mobile communication terminal in accordance with the related art.

Initially, a user accesses a message menu of a mobile terminal by a key adjustment and then selects an outbox item in the menu (FIG. 1A). Predetermined sub-items are displayed in response to the selection. Then, the user selects the “new message” item among the sub-items (FIG. 1B). When the user selects “new message”, an input window for inputting message content to be transmitted to a plurality of receivers is displayed and thereby the user inputs a message content by a key adjustment (FIG. 1C). When the user finishes the message input and presses an OK key, a phone number window for inputting each receiver's phone number to which the broadcast message is to be transmitted is displayed (FIG. 1D). The user then inputs each receiver's phone number and transmits the message. At this time, the broadcast message is sequentially transmitted to each receiver's phone number.

When a mobile terminal receives the broadcast message which has been transmitted by said process, a user enters the message menu and selects an “inbox” item among sub items in the menu. (See FIG. 2A)

When “inbox” is selected, a list of received messages is displayed. (See FIG. 2B). In the list, a message which has been most recently received is selected and a content of the message is certified. (See FIG. 2C). Herein, the message is displayed not only with its content but also with a transmitter's phone number and a transmitted time.

However, in the aforementioned related-art method, it is impossible for the receiver a receiving party to determine whether or not a received message is a broadcast message. In the related-art method, it is impossible for the receiver a receiving party to determine other receivers' phone numbers to which the same broadcast message was transmitted.

### SUMMARY OF THE INVENTION

An object of the present invention is to solve one or more problems of the related-art and/or to achieve at least one of the following advantages.

Another object of the present invention is to provide a broadcast message service system and method for a mobile communication terminal, wherein whether each receiver's phone number is to be opened or not is set at the time of transmitting a broadcast message is transmitted and each receiver can certify the opened phone numbers.

Another object of the present invention is to provide a broadcast message service system and method in a mobile communication terminal, in which a receiver arbitrarily stores or edits opened phone numbers at the time a broadcast message is received.

To achieve these and other objects and advantages, the present invention provides a broadcast message service system and method for a mobile communication terminal which in accordance with one embodiment comprises a transmission process which inputs a broadcast message and receivers' phone numbers and sets whether each receiver's phone number is to be opened or not, and a reception process for receiving the broadcast message and certifying the message content and the opened receivers' phone numbers.

According to a second embodiment, the broadcast message service system and method comprises inputting a short message content and receivers' phone numbers setting whether each receiver's phone number is to be opened or not and transmitting the short message to each receiver.

According to a third embodiment, the broadcast message service system and method comprises judging whether a received short message is a broadcast message and if the received message is a broadcast message detecting a message content, a transmitter's phone number, and opened receivers' phone numbers The detected contents may then be output on a display unit of the mobile communication terminal.

According to a fourth embodiment, the broadcast message service system and method comprises judging whether a received short message is a broadcast message and if the received message is a broadcast message displaying a message content, a transmitter's phone number, and opened receivers' phone numbers on a display unit of the mobile communication terminal. Additional steps include selectively performing a reply for the received short message and storing phone numbers selected from the transmitter's phone number and a list for the opened receivers' phone numbers.

### BRIEF DESCRIPTION OF THE DRAWINGS

FIGS. 1A, 1B, 1C, and 1D are exemplary views showing a broadcast message transmitting method in a mobile communication terminal in accordance with the related art.

FIGS. 2A, 2B, and 2C are exemplary views showing a broadcast message receiving method in a mobile communication terminal in accordance with the related art.

FIG. 3 is a flow chart showing a broadcast message transmitting method in a mobile communication terminal according to the present invention.

FIGS. 4A and 4B are exemplary views showing one embodiment of a broadcast message transmitting process in a mobile communication terminal according to the present invention.

FIG. 5 is a flow chart showing a broadcast message receiving process in a mobile communication terminal according to the present invention.

FIGS. 6A, 6B, and 6C are exemplary views showing a broadcast message receiving process in a mobile communication terminal according to the present invention.

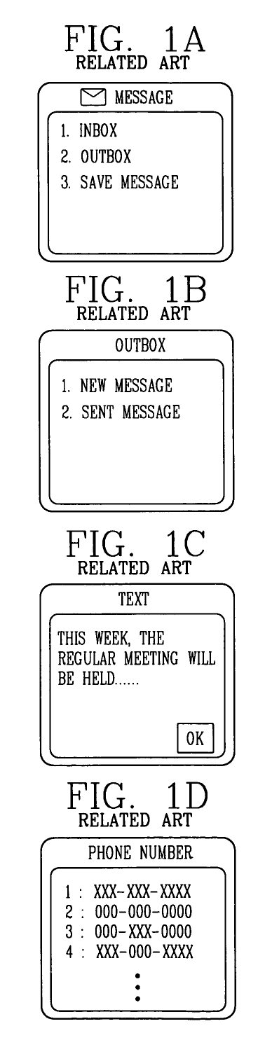

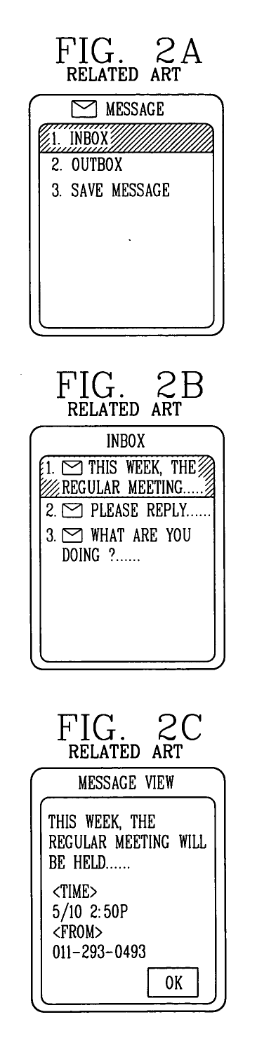

### DETAILED DESCRIPTION OF THE PREFERRED EMBODIMENTS

In accordance with one embodiment, a broadcast message service method according to the present invention comprises: writing a broadcast message in a transmitter, selecting or otherwise entering phone numbers of a plurality of receivers of the broadcast message, setting whether each phone number is to be opened or not, thus transmitting the broadcast message. Each receiver of the broadcast message may then certify the message content and the opened phone numbers. At this time, a receiver can perform a reply for the opened phone numbers or can store each phone number in a mobile communication terminal.

In the aforementioned transmitting process, a data frame including a text message and a list of the opened phone numbers may be transmitted. In contrast, in the mobile communication system according to the related art, an amount of text messages and a data amount of phone numbers which can be used as a call back number are limited. Therefore, in order to apply the broadcast message service method in a mobile communication terminal according to the present invention, a new data frame for transmitting the list of the opened phone numbers may advantageously be provided.

More specifically, a predetermined number (e.g., 2) data frames may be used. A first data frame includes the message content and the transmitter's phone number, and a second data frame is for transmitting the opened phone numbers. Herein, the data frame for transmitting the opened phone numbers uses a margin field among fields for transmitting the text message. Thus, if a broadcast message according to the present invention is received by using a mobile communication terminal according to the related art, opened receivers' phone numbers cannot be certified even though the text message content and the transmitter's phone number can be certified.

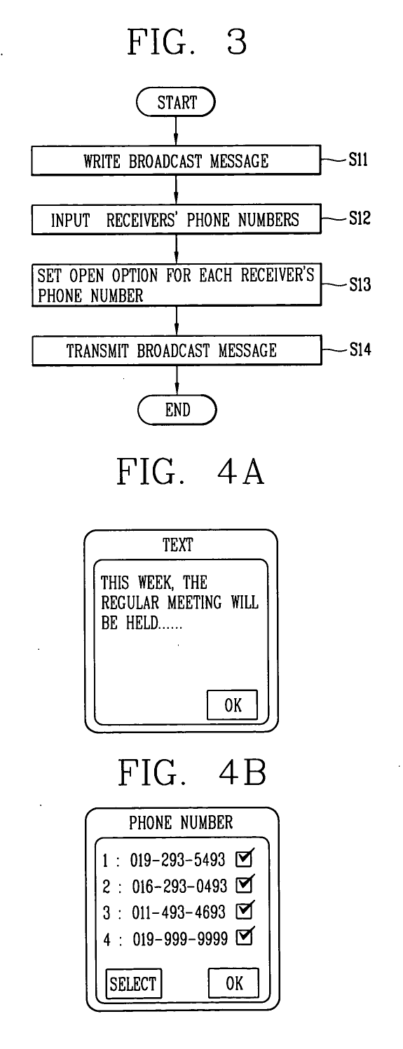

FIG. 3 is a flow chart showing steps included in a broadcast message transmitting method for a mobile terminal according to one embodiment of the present invention. As shown, a user writes a broadcast message to be transmitted by a key adjustment (S11), and inputs receivers' phone numbers (S12). The user then sets whether each receiver's phone number is opened or not(S13), and transmits a data frame including the broadcast message content, the transmitter's phone number, and the opened receivers' phone numbers (S14).

FIGS. 4A and 4B are exemplary windows generated by the broadcast message transmitting process according to the present invention. First, a user enters a predetermined menu, that is, a message menu, by performing a key adjustment of a mobile terminal. An “outbox” item is then selected from among a plurality of new sub items.

If the user selects a new message item among the sub-items in the outbox, a message input window is displayed as shown in FIG. 4A. The user then inputs a text message content to be transmitted.

When the user presses a certification key after inputting the text message, a phone number input window for inputting receivers' phone numbers to which the text message will be transmitted is displayed, as shown in FIG. 4B. According to this, the user inputs receivers' phone numbers and sets whether each inputted phone number is to be opened or not.

For example, if the number of inputted receivers' phone numbers is 10 and the number of opened receivers' phone numbers is 5, a mobile terminal which has received the broadcast message displays only the five opened receivers' phone numbers.

When the broadcast message content and the receivers' phone numbers are set and whether or not each receiver's phone number is to be opened not is set, a data frame including the message content and the transmitter's phone number and a data frame including the opened receivers' phone numbers are transmitted.

Herein, even if the opened receivers' phone numbers do not exist, a data frame including a header for a broadcast transmission is transmitted. That is, even though the opened receivers' phone numbers do not exist at the time the broadcast message is transmitted, a data frame allocated to transmit the opened receivers' phone numbers may always be transmitted.

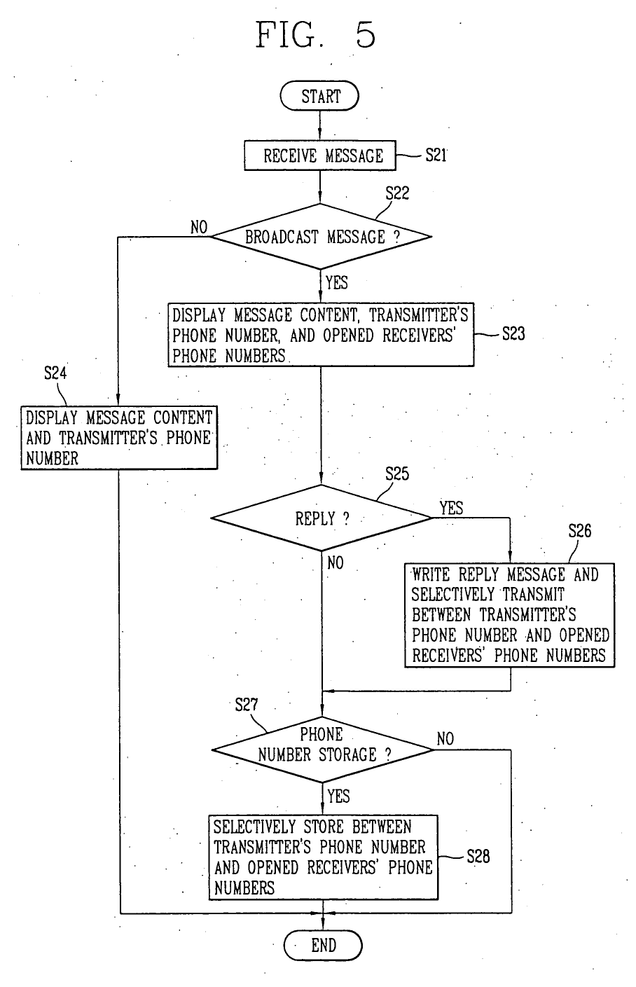

FIG. 5 is a flow chart showing steps included in a broadcast message receiving process for a mobile terminal according to an embodiment of the present invention. If the mobile terminal receives a message (S21), it is certified whether or not the message is a broadcast message (S22).

If the message is a broadcast message, the message content, the transmitter's phone number, and the opened receivers' phone numbers are displayed on a display unit of the mobile communication terminal (S23). On the other hand, if the message is a general short message and not a broadcast message, the message content and the transmitter's phone number are displayed on the display unit (S24).

The user certifies content of the broadcast message and determines whether or not to send a reply for the corresponding message (S25). If the user determines to send the reply, a message is written and a phone number to which a reply message will be sent is selected between the transmitter's phone number of the broadcast message and the opened receivers' phone numbers (S26).

After the reply for the broadcast message is completed, the user judges whether or not to store the transmitter's phone number and the opened receivers' phone numbers (S27) and thereby selectively stores the transmitter's phone number and the opened receivers' phone numbers (S28).

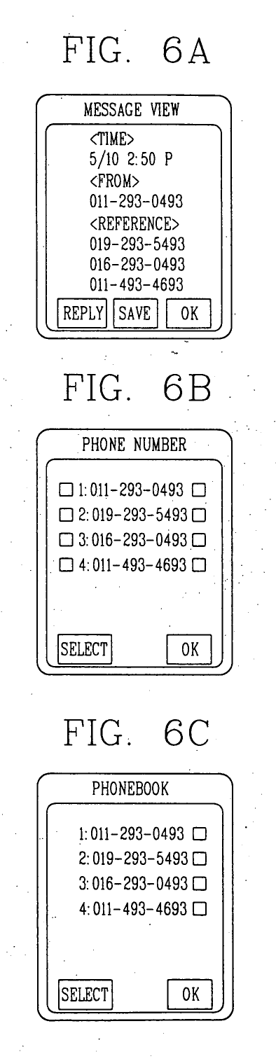

FIGS. 6A, 6B, and 6C are exemplary views showing a broadcast message receiving process in a mobile communication terminal according to the present invention. When a message is received by a mobile terminal, it is judged whether the message is a general short message or a broadcast message. Herein, a kind of the received message can be judged, for example, by the number of received data frames or information included in a header of the data frame.

If the received message is a general short message, a content of the message and the transmitter's phone number are detected and are displayed on the display unit of the mobile communication terminal.

If the received message is a broadcast message, content of the message, the transmitter's phone number, and the opened receivers' phone numbers are detected to be displayed on the display unit of the mobile communication terminal as shown in FIG. 6A. At this time, if the opened receivers' phone numbers do not exist, a preset sentence such as “There is no opened receiver's phone number” is displayed to inform the user that the received message is a broadcast message.

The opened receivers' phone numbers may be displayed at a mobile terminal to which the broadcast message service method according to the present invention is applied, but cannot be displayed at a related-art mobile terminal.

If the user certifies the broadcast message and inputs a reply command_by pressing a predetermined key in order to reply for the received message as shown in FIG. 6B, the transmitter's phone number and a list for the opened receivers' phone numbers are displayed.

The user selects phone numbers to which a reply for the broadcast message will be transmitted from the phone number list, and inputs a reply message content thus to transmit. If the reply message is a broadcast message, the user can set whether the selected phone numbers are to be opened or not.

A predetermined phone number included in the list can be stored in a phone directory mounted in the mobile communication terminal by pressing a preset storage key. That is, if a preset storage key is pressed under a state that the broadcast message has been displayed on the display unit of the mobile communication terminal, as shown in FIG. 6C, the transmitter's phone number of the broadcast message and the list for the opened receivers' phone numbers are output. If the list includes a phone number identical to a phone number which has been registered in the phone book of the mobile terminal, the phone number is displayed as information which has been registered in the mobile terminal.

If the user selects phone numbers to be stored from the list and inputs an “OK” key, the selected phone numbers are registered in the phone directory of the mobile terminal. When the user presses the “OK” key, a phone number registration window is displayed on the display unit. If the user inputs a name or predetermined information to the phone number registration window and presses the “OK” key, the corresponding phone number is stored.

In the broadcast message service method for a mobile communication terminal according to the present invention, a content of the broadcast message, the transmitter's information, and the opened receivers' phone numbers are displayed at the time of receiving the broadcast message. According to this, other receivers' phone numbers to which the same broadcast message has been transmitted can be certified. Also, the transmitter's phone number and the opened receivers' phone numbers for the broadcast message can be stored or edited by a receiver's arbitrary handling, and the receiver can selectively transmit a reply message, thereby increasing the user's convenience.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A broadcast message service method, comprising:
transmitting a broadcast message with information indicating a number of receivers' phone numbers and whether or not each receiver's phone number is to be opened; and
receiving the broadcast message and certifying content of the message and the opened receivers' phone numbers.

2. The method of claim 1, wherein transmitting the broadcast message includes:
entering a broadcast message and receivers' phone numbers into a mobile terminal; and
setting whether or not each receiver's phone number is to be opened.

3. The method of claim 1, wherein the broadcast message includes:
a first data frame including the message content and the transmitter's phone number; and
a second data frame including the opened phone numbers.

4. The method of claim 1, wherein receiving the broadcast message comprises:
detecting the broadcast message content, the transmitter's phone number, and the opened receivers' phone numbers; and
displaying the detected contents on a display unit of the receiving mobile terminal.

5. The method of claim 1, wherein receiving the broadcast message comprises:
selectively replying to the opened receivers' phone numbers; and
selectively storing the opened receivers' phone numbers.

6. A broadcast message service method comprising:
inputting content of a message and a number of receivers' phone numbers;
inputting whether or not each receiver's phone number is to be opened; and
transmitting the message to the receivers' phone numbers.

7. The method of claim 6, wherein the message includes:
a first data frame including the message content and the transmitter's phone number; and
a second data frame including the opened phone numbers.

8. The method of claim 7, wherein the second data frame includes the margin field for transmitting the message.

9. A broadcast message service method, comprising:
judging whether or not a received message is a broadcast message;
if the received message is a broadcast message, detecting opened receivers' phone numbers; and
displaying contents of the received message including a list of the detected opened phone numbers on a display unit of a mobile terminal which received the message.

10. The method of claim 9, further comprising:
performing a reply for the broadcast message.

11. The method of claim 10, wherein the reply for the broadcast message is performed by selectively designating phone numbers from the transmitter's phone number and a list for the opened receivers' phone numbers.

12. The method of claim 11, wherein the reply is transmitted by setting whether or not each selected phone number is to be opened.

13. The method of claim 9, further comprising:
storing phone numbers selected from the transmitter's phone number and a list for the opened receivers' phone numbers.

14. The method of claim 9, wherein of judging a broadcast message is performed by using the number of data frames included in a message or information included in a header of the data frame.

15. A broadcast message service method, comprising:
judging whether or not a received message is a broadcast message;
if the received message is a broadcast message, displaying content of a message, a transmitter's phone number, and opened receivers' phone numbers on a display unit;
selectively forming a reply to the received message; and
storing phone numbers selected from the transmitter's phone number and a list for the opened receivers' phone numbers.

16. The method of claim 15, wherein forming the reply comprises:
writing content of a message;
selecting phone numbers to be transmitted from the transmitter's phone number and the list for the opened receivers' phone numbers of the received message;
setting whether or not the selected phone number is to be opened; and
transmitting the reply message.

17. The method of claim 15, wherein, if the transmitter's phone number and the opened receivers' phone numbers are phone numbers which have been stored in the mobile terminal, the phone numbers are displayed as pre-stored information.

18. A mobile terminal, comprising:
a display; and
a processor which determines whether a received message is a broadcast message.

19. The terminal of claim 18, wherein the processor determines whether the received message includes an opened phone number of at least one party.

20. The terminal of claim 19, wherein the display outputs the opened phone number of said at least one party.

21. The terminal of claim 18, wherein the processor determines whether the received message is a broadcast message based on a number of frames in the received messages.

22. The terminal of claim 21, wherein the number of frames includes:
a first frame containing contents of the received message and a phone number of a transmitter; and
a second frame includes a list of opened phone numbers.

23. The terminal of claim 19, further comprising:
a transmitter which transmits a reply message to the received message,
wherein the processor generates a reply message which includes the opened phone number if selected.

24. The terminal of claim 19, wherein the processor stores the opened phone number in a phone book based on a user command.

25. A mobile terminal, comprising:
a detector which detects whether a received message includes one or more opened phone numbers; and
a display which displays the opened phone numbers.

26. The terminal of claim 25, wherein the display displays contents of the received message with the opened phone numbers.

27. The terminal of claim 26, wherein the display displays a phone number of a transmitting party.

28. A mobile terminal, comprising:
a processor which generates a broadcast message including a number of receiver opened phone numbers; and
a transmitter which transmits the broadcast message.

29. The terminal of claim 28, wherein the number of receiver opened phone numbers is more than one.

30. The terminal of claim 28, wherein the transmitter transmits a first frame containing contents of the message and a second frame containing the number of receiver opened phone numbers.

31. The terminal of claim 30, wherein the first frame also contains a phone number of the terminal.
